(19) United States
(12) Patent Application Publication
(10) Pub. No.: US 2013/0200155 A1
(43) Pub. Date: Aug. 8, 2013

(54) OPTOELECTRONIC SENSOR AND METHOD FOR DETECTING OBJECT INFORMATION

(71) Applicant: SICK AG, Waldkirch (DE)

(72) Inventors: Helmut Weber, Waldkirch (DE); Ralf Ulrich Nubling, Waldkirch (DE)

(73) Assignee: SICK AG, Waldkirch (DE)

(21) Appl. No.: 13/748,620

(22) Filed: Jan. 24, 2013

(30) Foreign Application Priority Data
Jan. 26, 2012 (EP) 12152716.2

(51) Int. Cl. G06K 7/10

(52) U.S. Cl. CPC G06K 7/10831
USPC 235/454

(57) ABSTRACT

An optoelectronic sensor (10) has a light receiver (16) for converting received light from a detection area (12) into an electrical signal. The sensor (10) comprises an evaluation unit (18) for obtaining information about objects in the detection area (12) from the electrical signal and aiming means (22) having at least one light source (24) and a pattern generating element (28) to make the detection area (12) visible with a light pattern (36). The pattern generating element (28) comprises a plurality of cylindrical lenses (30, 32, 34) so that the generated light pattern (36) comprises a plurality of lines (38) showing the position of the detection area (12).

The invention relates to an optoelectronic sensor with aiming means and a method for detecting object information from a detection area and for visualizing the detection area according to the preamble of claim 1 and claim 12, respectively.

Optoelectronic sensors have a detection area towards which they need to be oriented for their operation. If the sensor does not have a visualization monitor, the detection area can only inadequately be recognized. Therefore, some sensors are equipped with aiming means visualising the detection area with a cross hair or some similar position-specific illumination marking.

A particular family of optoelectronic sensors are the code readers having a reading field within their detection area. Codes within the reading field are detected, and their code information is read. It is immediately apparent that a proper orientation of the code reader is required so that the code is within the reading field.

The most common code readers are bar code scanners scanning a barcode with a laser reading beam transverse to the code. They are often used at cashiers in supermarkets, for automatic packet identification, sorting of mail, baggage handling in airports and in other logistics applications. Further applications include quality or parts control in manufacturing processes. A bar code scanner automatically marks its reading field if a laser beam in the visible spectrum is used.

With the advancement of digital camera technology, bar code scanners are more and more replaced by camera-based code readers. Instead of scanning code areas, a camera-based code reader captures an image of the objects bearing the codes by means of a CCD-Chip or a CMOS-Chip. Camera-based code readers can easily handle plain writing and other types of codes than one-dimensional bar codes, which can also be two-dimensional like a matrix code, and which provide more information. For camera-based code readers, aiming means for marking the reading field or the object field are a very useful support.

An aiming device for an optoelectronic reading apparatus is for example presented in U.S. Pat. No. 6,060,722. It is based on a light source generating different aiming patterns in the detection area by means of an interference pattern element such as a diffractive optical element (DOE). However, the efficiency of a DOE is limited, and additionally DOEs are only adapted to a very small range of wave lengths. Moreover, the manufacturing by injection moulding is particularly challenging, and making the master is extremely costly.

Aiming devices are also known from completely different technical areas. In U.S. 2002/0012898 A1 or in U.S. Pat. No. 6,997,716 B2, a laser cross hair is generated to automatically detect the location to which a weapon is directed within a computer simulation. To that end, the laser light is detected where it impinges. Insofar as no invisible IR light is used in the first place, the visualization is at least only a side effect, because the true purpose of the laser cross hair is the automatic detection of the virtual point of entry.

It is therefore an object of the invention to mark the detection area of an optoelectronic sensor in an improved manner.

This object is satisfied by an optoelectronic sensor having a light receiver for converting received light from a detection area into an electrical signal, the sensor comprising an evaluation unit for obtaining information about objects in the detection area from the electrical signal and aiming means having at least one light source and a pattern generating element to make the detection area visible with a light pattern, wherein the pattern generating element comprises a plurality of cylindrical lenses so that the generated light pattern comprises a plurality of lines showing the position of the detection area.

The object is also satisfied by a method for detecting object information from a detection area and for visualizing the detection area, wherein a light receiver converts received light from the detection area into an electrical signal which is evaluated to obtain the object information, and wherein a light pattern is generated in the detection area to make the detection area visible, wherein the light pattern is generated as a plurality of lines by means of a plurality of cylindrical lenses, the position of the detection area being shown by the lines.

The invention starts from the basic idea to generate the light pattern with refractive means. Therefore, a plurality of cylindrical lenses is used to focus the light of the light source of the aiming means in a plurality of lines. From the plurality of lines, the position of the detection area can be derived, for example by the lines crossing in the center of the detection area or surrounding the detection area itself, or by the lines marking corners of a center portion or of the entire detection area.

A plurality of light sources can be used instead of only one light source in order to generate a higher optical output power, or to illuminate the pattern generating element at several positions to get a desired illumination profile, in particular one that is homogenous or somewhat increased in an edge region.

The invention has the advantage that the aiming means are very inexpensive and at the same time enable generation of a plurality of light patterns in accordance with the requirements of the application. The aiming means for themselves do not need an adjustment and work as long as the optical axis of the light source is sufficiently aligned with the optical axis of the light receiver. As compared to a DOE, the requirements for the light source are substantially lower since almost no optical output power is lost in the pure redistribution of refraction, and there is practically no limit for the required range of light wavelength.

The sensor preferably is a code reader whose evaluation unit is configured to obtain information about code areas in the detection area from the electrical signal and to read code information from the code areas. Throughout this specification, the term preferably describes preferred, but optional features that are not necessarily required for the invention. In this embodiment, the detection area includes the reading field in which codes to be read can be detected and decoded. For both code readers in manual operation and in fixed installation, such as at a conveyor belt or in a reading tunnel, it is important to know where the reading area is located.

The code reader is preferably a camera-based code reader whose light receiver is a matrix-shaped or a line-shaped image sensor. Then, not only one-dimensional, but also two-dimensional codes can be decoded by image processing.

The cylindrical lenses are preferably oriented with respect to one another in different directions so that the lines in the generated light pattern are oriented with respect to one another at an angle. The cylindrical lenses are thus rotated in a plane orthogonal to the optical axis of the light source so that their focal lines, and therefore also the lines of the light pattern, cross in the detection area. In particular, the cylindrical lenses are oriented orthogonal to one another so that lines crossing orthogonally are generated in the detection area. By such lines, specific points in the detection area can be accurately marked.

The pattern generating element preferably comprises at least one micro lens array. This provides a plurality of cylindrical micro lenses by means of which a desired light pattern can be generated from some or even lots of lines in various configurations. It is also conceivable to provide more than one micro lens array. These arrays either form a larger micro lens array by directly abutting on one another, or they form an arrangement of a plurality of isolated micro lens arrays. In the latter case, each micro lens array preferably has its own light source. Use of multiple light sources can also be advantageous for a single micro lens array or a larger composite micro lens array in order to obtain a more intense illumination or a desired illumination profile, respectively.

The cylindrical lenses preferably have the same orientation within a group, whereas different groups of cylindrical lenses have different orientation, so that each group generates a line of one orientation within the detection area. If, for example, a horizontal and a vertical group is provided, a cross hair or somewhat generalized a right angle corner is generated. If the orientation differs from a horizontal and vertical orientation, the generated pattern rotates. By deviation in only one group, the included angle is varied. The groups can be formed as a regular pattern on the micro lens array, for example with alternating horizontal and vertical orientation. Thus, the micro lens array is more regular. However, the same effect for the light pattern can also be obtained with irregular arrangements of the groups. By a larger number of groups, the number of lines in the light pattern is also increased.

The micro lens array preferably also comprises non-cylindrical lenses. For example, the cylindrical lenses have aspheric components, or convex lenses for generating light points are provided. Thus additional degrees of freedom for the design of the light pattern are opened.

The micro lenses preferably have different focal lengths or sizes. With that, more properties of the light pattern can be influenced and varied.

At least one micro lens of the micro lens array is preferably oriented at a tilt angle with respect to a plane of the micro lens array, or at least one micro lens of the micro lens array is wedge-shaped. This in effect tilts the optical axis of this lens in relation to the optical axis of the light receiver, so that the two-dimensional area that can be reached by the light pattern within the detected area is increased.

The micro lens array is preferably integrated into optics of the light source, into optics of a light transmitter for illuminating the detection area, or into a front screen of the sensor. Then, no additional component is required, and a separate adjustment is eliminated. The pattern generating element may directly be applied to the optics or the front screen.

The method in accordance with the invention can be further developed in a similar manner with additional features and shows similar advantages. Such advantageous features are described in an exemplary, but not exclusive manner in the dependent claims following the independent claims.

The invention will be explained in the following also with respect to further advantages and features with reference to exemplary embodiments and the enclosed drawing. The Figures of the drawing show in:

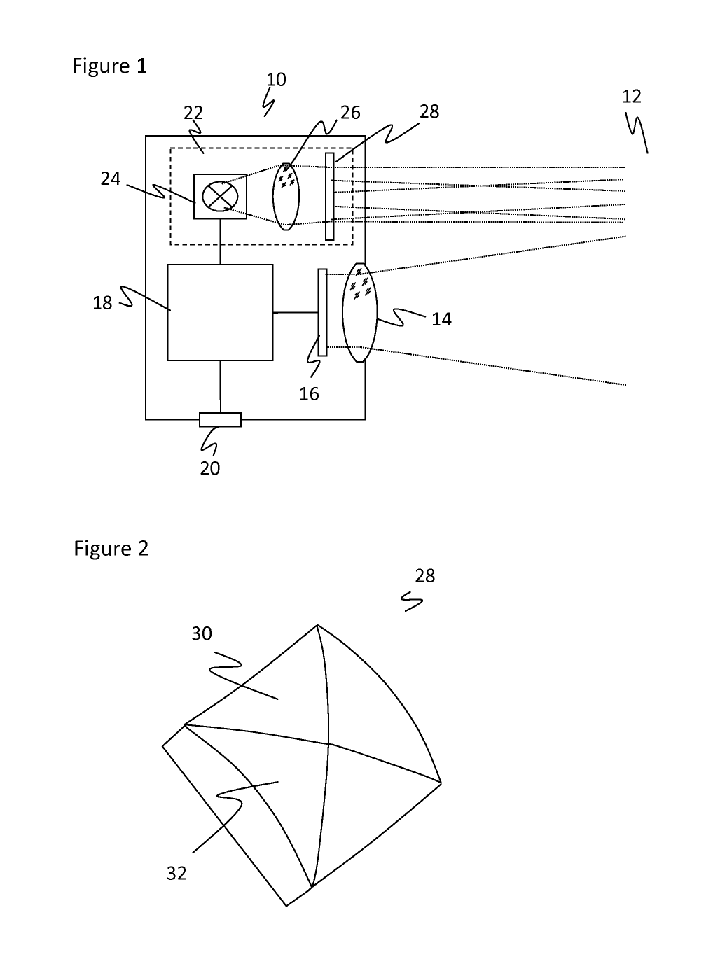

FIG. 1 a schematic sectional view of an optoelectronic sensor with aiming means;

FIG. 2 a three-dimensional view of an integral crossed cylinder lens;

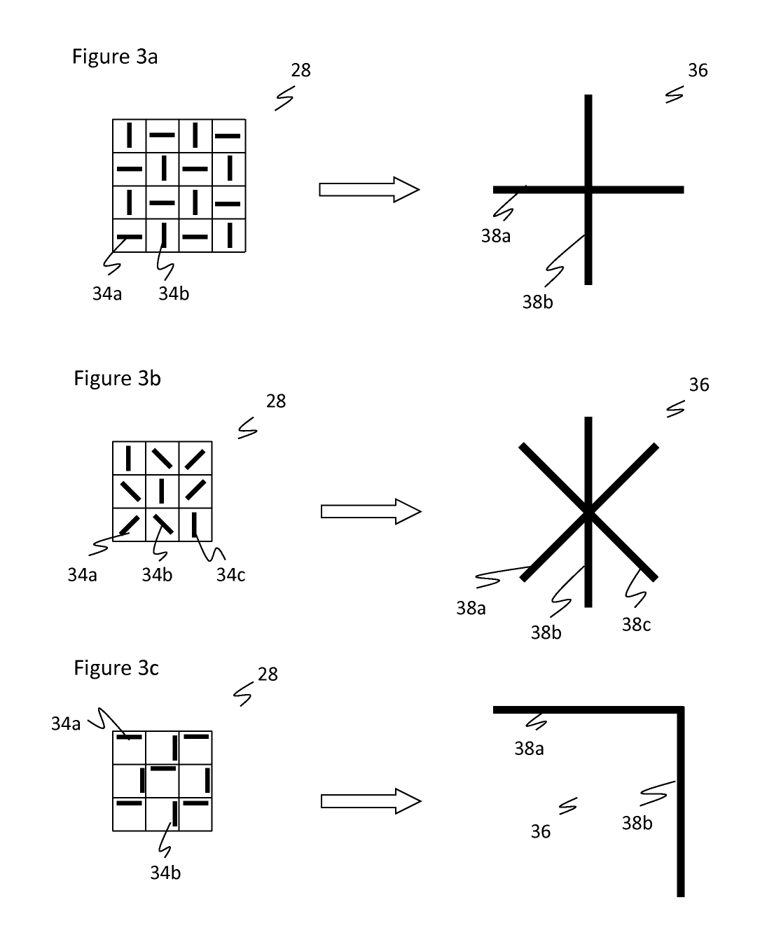

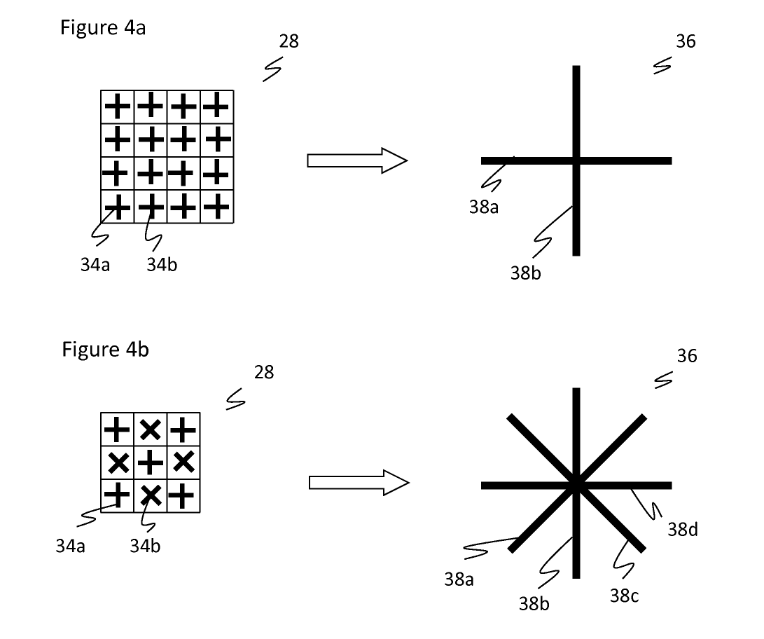

FIG. 3a-c various group configurations of differently oriented cylindrical micro lenses and a respective light pattern generated by them; and FIG. 4a-b alternative group configurations for generating the light pattern according to FIGS. 3a-c.

FIG. 1 shows a schematic sectional view of an optoelectronic sensor 10. The sensor for example is a code reader, but can also be a different optoelectronic sensor 10 whose detection area is to be adjusted and which therefore benefits from visualization by aiming means.

The sensor 10 receives light from a detection area 12. In the case of a code reader, for example objects with the code to be read can be located there. The light from the detection area 12 is received through a photo objective or reception optics which are represented in simplified form by a lens 14. A light receiver 16 converts the received light into an electrical signal. The light receiver may for example be a photo diode or, as in the case of a camera-based code reader, a CCD chip or a CMOS chip with a plurality of pixels arranged in a line or a matrix.

The electrical signal is fed to an evaluation unit 18 which obtains object information of the detection area 12 from the electrical signal. In the example of a code reader, the electrical signal includes image data from a reading field in the detection area 12. In this image data, code areas are located, and the code information within code areas is decoded. The result of the evaluation is provided at an output 20. In an alternative embodiment, not shown, raw data in various pre-processing states is output, and the entire evaluation or parts of the evaluation are done externally.

The sensor 10 further comprises aiming means 22 with a light source 24, for example a semi-conductor light source such as an LED, a laser diode, or a VCSEL in the visible spectrum, with optional optics 26 for collimation and with a pattern generating element 28. By that means, a light pattern is generated in the detection area 12 to visualize the position of the detection area 12 and thus be able to aim the sensor 10 at a desired detection area 12.

In addition, the sensor 10 may comprise a further active illumination which is not shown. This is to illuminate for example codes for improved readability.

FIG. 2 show a first embodiment of the pattern generating element 22 as a three-dimensional contour. The light source 24 is focused at the target distance by means of optics 26. The pattern generating element comprises two cylindrical lenses 30, 32 whose focal lines are oriented orthogonally to one another. Instead of two separate cylindrical lenses 30, 32, a one-piece or integral pattern generating element 28 is formed where two crossed cylindrical lenses 30, 32 are integrated by its shape. Each of the two cylindrical lenses 30, 32 generates a respective line in the detection area 12. Due to the crossed arrangement of the two cylindrical lenses 30, 32, a cross hair is generated by the lines in the detection area 12.

The cylindrical lenses 30, 32 in the pattern generating element 28 may be classical lenses or Fresnel lenses and either concave or convex. An additional aperture or a tilting against the orientation with respect to the optical axis of the light receiver 16 in a specific target distance is possible.

FIGS. 3a-c show other embodiments of pattern generating elements 28. Common to these embodiments is that the pattern generating element 28 comprises a micro lens array with a plurality of cylindrical micro lenses 34. The grid or size, respectively, and the mutual distance (pitch) of the cylindrical micro lenses 34 is in a range of about one tenth of a millimeter up to several millimeters, for example in a range of 0.5 mm to 3 mm. Furthermore, the pattern is generated by refraction in the individual cylindrical micro lenses. The beam diameter of the illumination from the light source 24 is larger than the grid, so that several or all of the cylindrical micro lenses 34 are within the beam path. Deviating from the representations, the elements may have other shapes instead of a square shape, such as rectangular, hexagonal, or the like.

The cylindrical micro lenses 34 are aligned in at least two groups. Within the group, the cylindrical micro lenses 34 have the same orientation, but the groups have different orientation among each other. Therefore, a plurality of lines in various patterns is generated, of which FIGS. 3a-c show some examples.

FIG. 3a shows in the left part an example with two groups of cylindrical micro lenses 34a-b which are alternately tilted by 90° to each other like on a checkerboard. In the representation, the optical axis of the light source 24 is perpendicular to the paper plane. As shown on the right in FIG. 3a, both groups of cylindrical micro lenses 34a-b generate one line 38a-b each in the resulting light pattern 36, together forming a cross. In the center of the light pattern 36, there is an intensity peak because here light from both groups of cylindrical micro lenses 34a-b is superimposed.

FIG. 3b shows in an analogous manner an example of three groups of cylindrical micro lenses 34a-c resulting in a light pattern 36 of three crossing lines 38a-c. The arrangement of the cylindrical micro lenses 34a-c within the micro lens array can be regular as shown. However, as long as the dimensions of the cylindrical micro lenses 34a-c are small as compared to the beam width, this arrangement is of little consequence and can be changed almost arbitrarily.

FIG. 3c shows a further example of two groups of cylindrical micro lenses 34a-b which are not centered within the grid of the micro lens array or which are wedged, respectively. Therefore, although the generated lines 38a-b are crossed in the light pattern 36, the crossing is also not centered. In this case, the deviation from a centered crossing is even extreme, so that the lines 38a-b intersect in a corner and the light pattern 36 thus forms a right angle corner.

FIGS. 4a and 4b show alternative examples of groups of cylindrical micro lenses 34a-b. Here, in contrast to the examples of FIGS. 3a-c, the cylindrical micro lenses themselves are already formed for refraction in two axes, similar to the pattern generating element 28 shown in FIG. 2 into which two cylindrical lenses 30, 32 are integrated by its shape. The respective resulting light pattern 36 is also shown. For the regular arrangement of the cylindrical micro lenses 34a-b of FIG. 4a, it is a simple cross. In the case of the alternating arrangement of the cylindrical micro lenses 34a-b according to FIG. 4b, it is a rotated double cross, where an additional horizontal line 38d is added to the lines of FIG. 3b.

The constellations in the FIGS. 3 and 4 are only some examples from a plurality of orientations and arrangements by which cylindrical micro lenses 34 can generate a light pattern 36 from a plurality of lines 38. However, even further variations are possible. The cylindrical micro lenses can be classic or Fresnel lenses. The micro lens array can be tilted as a whole, or only some individual micro lenses are tilted or provided with a wedge element. Such tilt and wedge effects can be used for beam deflection by which a distribution into larger area two-dimensional patterns can also be achieved without crossing the individual lines 38.

More complex structures of the light pattern 36 can be generated by additional degrees of freedom. In addition to cylindrical micro lenses 34, non-cylindrical elements are conceivable, for example to obtain a collimation in single light points. The individual micro lenses can not only have different orientation, but also different focal lengths, sizes, tilting or contours for example with aspheric components. Additional light sources can be provided in order to sufficiently illuminate the micro lens array. It is also possible to illuminate several micro lens arrays or partial areas of micro lens arrays with a respective own light source, so that several light patterns 36 in different areas of the detection area 12 are generated. For example, several corners of a selected center area or of the detection area 12 itself are marked in this way.

In another embodiment, the pattern generating element 28 is not a separate element, but the micro lens array is directly formed on the collimator lens 26, transmission optics of an additional light transmitter, or a front screen of the sensors 10.

By the illumination of many micro lenses, the pattern generating element is very position insensitive. Therefore, no specific measures are required for adjustment. Due to the high number of individual micro lenses, laser protection admits a higher transmission power of the aiming means 22 which in turn leads to an improved visibility of the light pattern 36.

1. An optoelectronic sensor (10) having a light receiver (16) for converting received light from a detection area (12) into an electrical signal, the sensor (10) comprising an evaluation unit (18) for obtaining information about objects in the detection area (12) from the electrical signal and aiming means (22) having at least one light source (24) and a pattern generating element (28) to make the detection area (12) visible with a light pattern (36),
characterized in that the pattern generating element (28) comprises a plurality of cylindrical lenses (30, 32, 34) so that the generated light pattern (36) comprises a plurality of lines (38) showing the position of the detection area (12).

2. The sensor (10) according to claim 1,
the sensor (10) being a code reader whose evaluation unit (18) is configured to obtain information about code areas in the detection area (12) from the electrical signal and to read code information from the code areas.

3. The sensor (10) according to claim 2,
wherein the code reader is a camera-based code reader whose light receiver (16) is a matrix-shaped or a line-shaped image sensor.

4. The sensor (10) according to claim 1,
wherein the cylindrical lenses (30, 32, 34) are oriented with respect to one another in different directions so that the lines (38) in the generated light pattern (36) are oriented with respect to one another at an angle.

5. The sensor (10) according to claim 1,
wherein the pattern generating element (28) comprises at least one micro lens array.

6. The sensor (10) according to claim 1,
wherein the cylindrical lenses (30, 32, 34) have the same orientation within a group, whereas different groups of cylindrical lenses (30, 32, 34) have different orientation, so that each group generates a line (38) of one orientation within the detection area (12).

7. The sensor (10) according to claim 5,
wherein the micro lens array also comprises non-cylindrical lenses.

8. The sensor (10) according to claim 5,
wherein the micro lenses (34) have different focal lengths or sizes.

9. The sensor (10) according to claim 5,
wherein at least one micro lens (34) of the micro lens array (28) is oriented at a tilt angle with respect to a plane of the micro lens array (28).

10. The sensor (10) according to claim 5,
wherein at least one micro lens (34) of the micro lens array (28) is wedge-shaped.

11. The sensor (10) according to claim 5,
wherein the micro lens array (28) is integrated into optics of the light source (24), into optics of a light transmitter for illuminating the detection area (12), or into a front screen of the sensor (10).

12. A method for detecting object information from a detection area (12) and for visualizing the detection area (12), wherein a light receiver (16) converts received light from the detection area (12) into an electrical signal which is evaluated to obtain the object information, and wherein a light pattern (36) is generated in the detection area (12) to make the detection area (12) visible,
characterized in that the light pattern (36) is generated as a plurality of lines (38) by means of a plurality of cylindrical lenses (30, 32, 34), the position of the detection area (12) being shown by the lines (38).
